(19) United States
(12) Patent Application Publication
(10) Pub. No.: US 2010/0131544 A1
(43) Pub. Date: May 27, 2010

(54) INTERACTIVE DATABASE

(76) Inventor: Simon M. Kilgour, London (GB)

Correspondence Address: RYAN KROMHOLZ & MANION, S.C., POST OFFICE BOX 26618, MILWAUKEE, WI, 53226, US

(21) Appl. No.: 12/312,241

(22) PCT Filed: Nov. 1, 2007
(86) PCT No.: PCT/GB2007/004169

§ 371 Date: Jan. 12, 2010

(30) Foreign Application Priority Data
Nov. 1, 2006 (GB) 0621770.7

(51) Int. Cl. G06F 17/30

(52) U.S. Cl. 707/769; 707/802; 707/705; 707/E17.014; 707/E17.044; 707/E17.005

(57) ABSTRACT

A computerised method of compiling a legal document between two or more parties, the method comprising:
determining a first user input defining a clause-type to be included in the document;
providing at least one sample statement for that clause-type; and
electing a sample statement for the clause-type for input to the legal document,
   wherein a party bias status is provided in relation to the at least one sample statement.

### FIELD OF THE INVENTION

The invention relates to computerised provision of legal agreements, in particular to an interactive database having the capability to provide customised legal agreements and their constituent clauses to users of the database.

### BACKGROUND

A typical reinsurance contract wording may be around 30 pages long, containing 20 to 30 clauses, but there are few standard forms as one would expect to find for certain classes of direct insurance. Although many individual clauses are commonly used in the reinsurance market, there tend to be small variations in these clauses that can have a great impact on the scope of cover and related liability.

From advising clients on disputes arising from reinsurance contract wordings, the inventors have identified that many of these disputes related to recurring issues, for example in relation to such small variations in wording, which could or should have been foreseen.

Furthermore, in 2006 the UK Financial Services Authority (FSA) put forward a Contract Certainty initiative for the London Insurance market, which raised the prospect of reinsurance contract wordings having to be agreed in full before inception of the contract, rather than with the traditional approach of agreeing key terms in a slip schedule and drafting the full wording some months after inception. Therefore, clients who underwrite reinsurance business would have much greater pressure to finalize dozens or hundreds of contracts in November and December prior to the traditional renewal date of 1^{st} January each year.

It is consequently a challenge to find a way of helping users to: (i) identify what was standard and what variations had been used, (ii) identify legal risk within contract wordings, and (iii) ensure that reinsurance underwriters have correctly priced the cover provided by the reinsurance.

It is an object of the invention to address one or more of the aforementioned problems.

### SUMMARY OF THE INVENTION

In a first aspect the invention provides a computerised method of compiling a legal document between two or more parties, the method comprising:
determining a first user input defining a clause-type to be included in the document;
providing at least one sample statement for that clause-type;
electing a sample statement for the clause-type for input to the legal document; and
compiling the legal document,
   wherein a party bias status is provided in relation to the at least one sample statement.

The party bias status is optionally provided in respect of the entire sample statement, and/or in respect of an attribute associated with the clause-type. The party bias status is optionally a graded party bias status, the graded party bias status optionally comprising at least three levels of grading comprising a set of one or more grades indicating a bias towards one party, a set of one or more grades indicating a bias towards the other party, and a grade indicating a neutral bias.

The method optionally comprises analysing the party bias status of two or more of an entire sample statement and/or of one or more attributes associated with a clause-type.

The method optionally comprises effecting a statistical analysis on a plurality of an entire sample statement and/or one or more attributes associated with a clause-type.

The method optionally comprises selecting one or more attributes and an entire sample statement in accordance with a predetermined overall bias level.

The method optionally comprises representing a party bias status and/or grading thereof by colour.

The method optionally comprises forming a matrix of a plurality of sample statements for each of which there is indicated a party bias status in relation to the sample statement.

The method optionally comprises compiling a legal document with at least one statement devised from electing the at least one sample statement for the clause type.

The invention can be implemented by means of a computer program product loaded into the internal memory of a digital computer, comprising software code portions for performing the method when the product is run on a computer. The computer program product may be in the form of a carrier, which may comprise electronic signals. The computer program is optionally distributed electronically.

In a second aspect the invention provides a database for the provision of a matrix on a website, the matrix comprising data relating to a clause-type to be included in a legal document between two or more parties; the matrix including a plurality of sample statements, for each of which there is indicated a party bias status in relation to the sample statement.

The database optionally comprises data for applying a party bias status in respect of the entire sample statement.

The database optionally comprises data for applying a party bias status in respect of each of one or more attributes associated with the clause-type.

The database optionally comprises data for applying a graded party bias status.

The database optionally comprises data for applying at least three levels of grading comprising a set of one or more grades indicating a bias towards one party, a set of one or more grades indicating a bias towards the other party, and a grade indicating a neutral bias.

In a third aspect the invention provides a website operable for compiling a legal document between two or more parties, the website comprising a matrix having data relating to a clause-type to be included in a legal document between the two or more parties, the matrix including a plurality of sample statements, for each of which there is indicated a party bias status in relation to the sample statement.

The database was initially created as a risk management tool to help primarily in-house Wordings and Legal departments, to stop their organisations making such common mistakes, and so to avoid foreseeable coverage disputes. The database can, however, also be used to assist Underwriting and Claims teams as well, and encompasses both inwards and outwards reinsurance business.

The inventors have created the database described herein to contain all of the known standard clauses in pages accessible by all users and bespoke clauses provided by individual users accessible by their organisation only. The clauses are grouped into categories of related clause types. Comments are provided on each clause. The database accessible typically through a dedicated internet website, which was developed to contain more than 2,500 pages.

A particular advantage of the database described herein is that clients are able to finalise more easily reinsurance contracts in time, while still ensuring the greatest degree of legal certainty possible.

### DETAILED DESCRIPTION

The invention will now be described by way of example only and with reference to the appended Figures, in which:

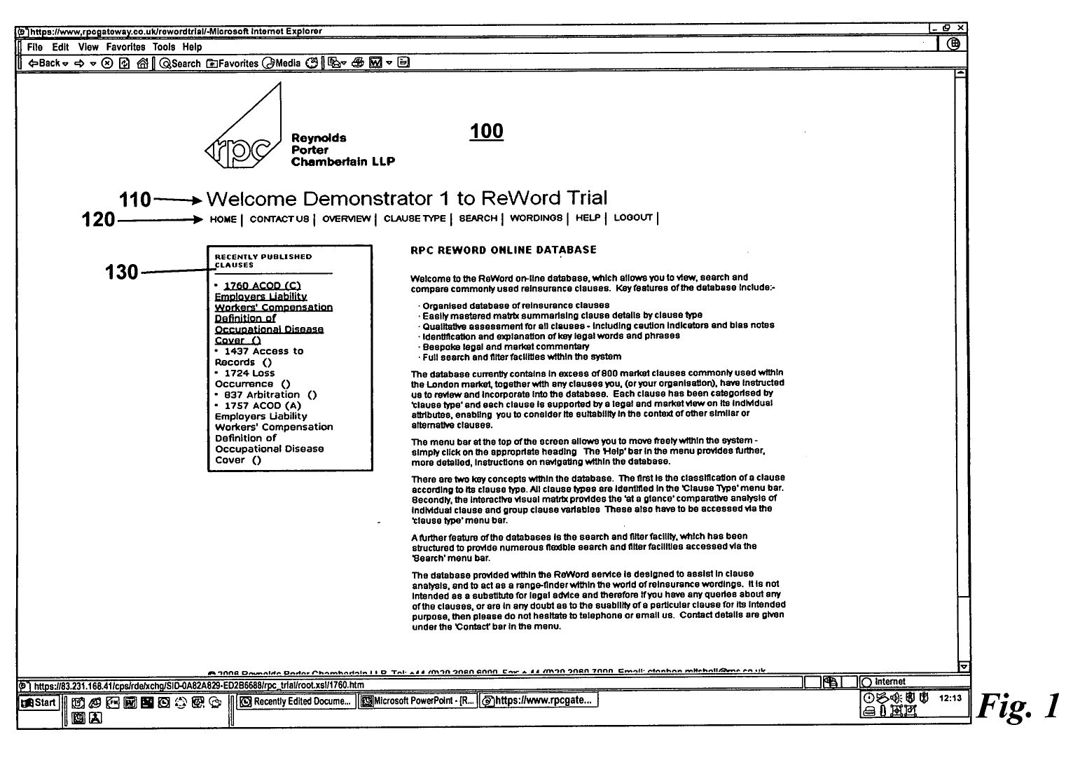

FIG. 1 illustrates a screenshot of an exemplary welcome screen of the database described herein;

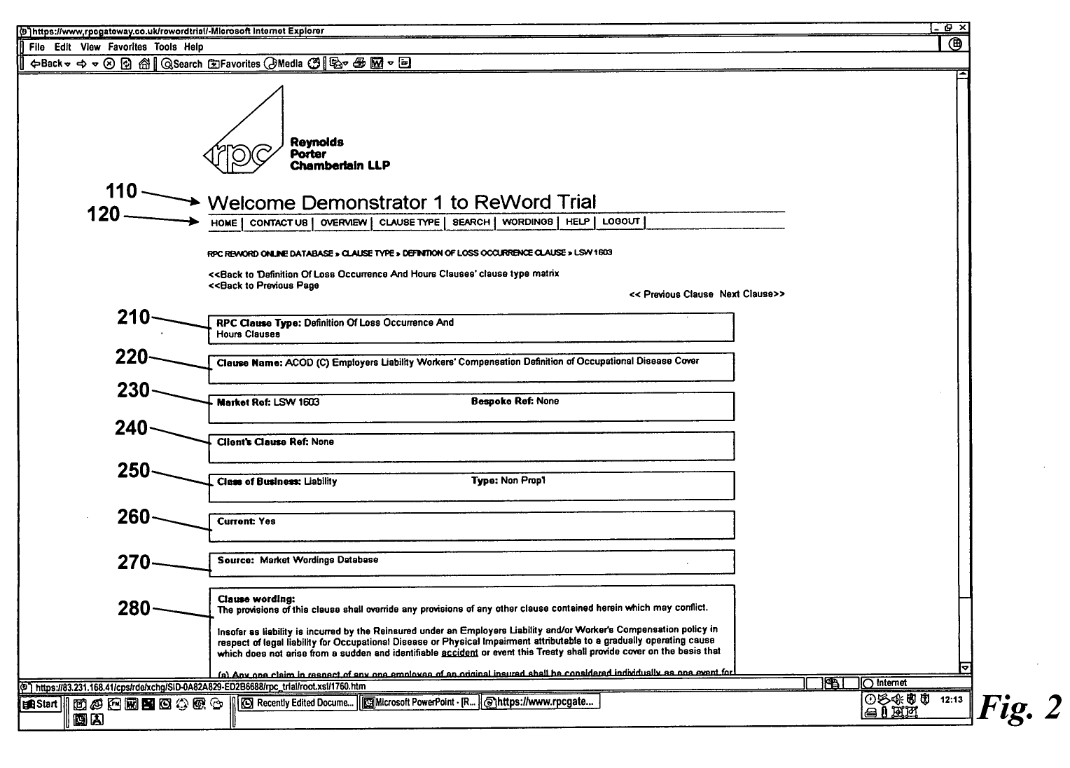

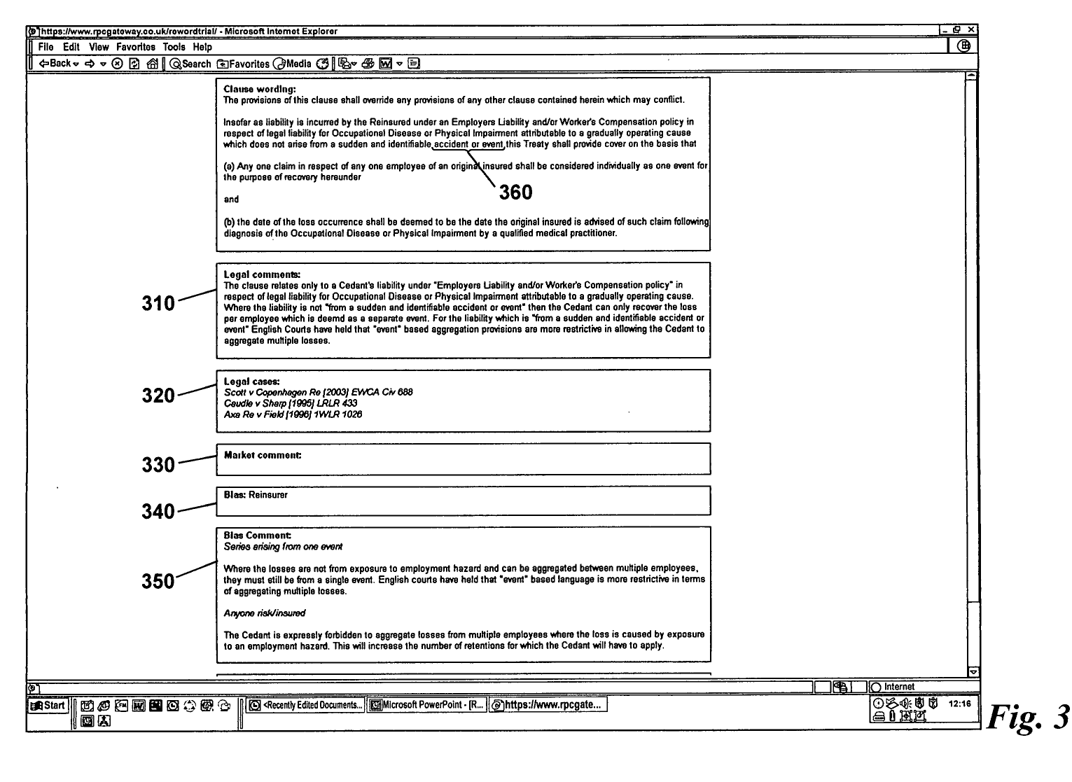

FIG. 2 illustrates a screenshot of an exemplary clause display screen;

FIG. 3 illustrates a screenshot of a further view of the exemplary clause display screen of FIG. 2;

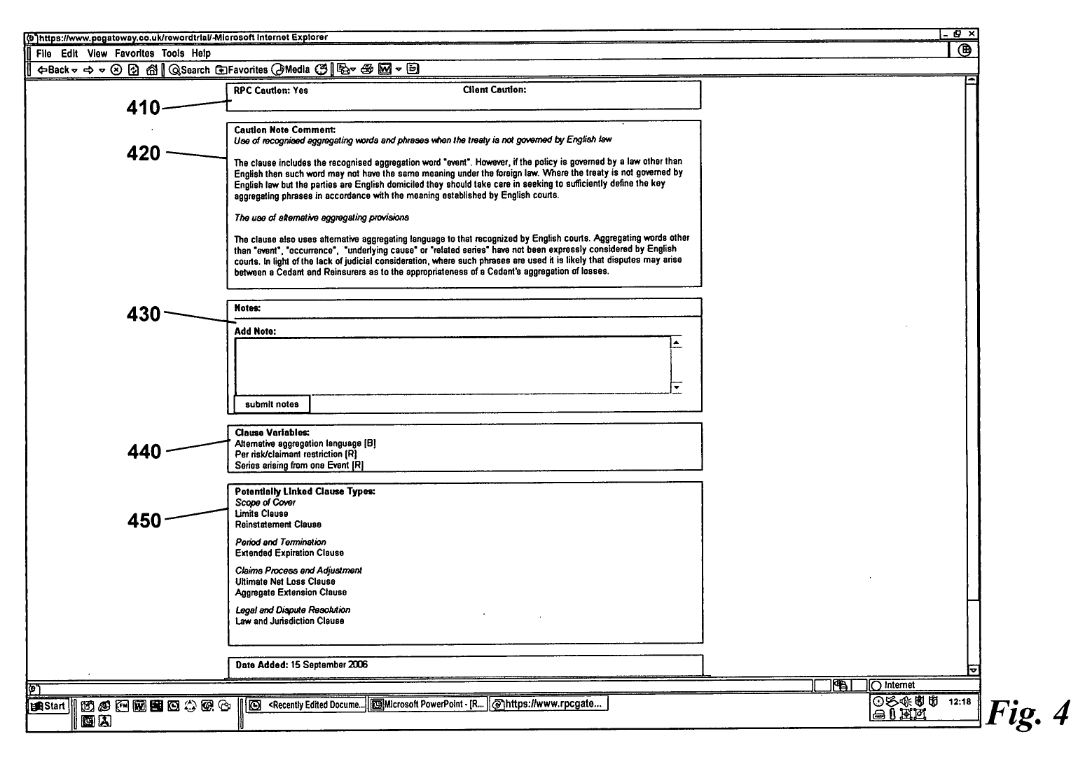

FIG. 4 illustrates a screenshot of a further view of the exemplary clause display screen of FIGS. 2 and 3;

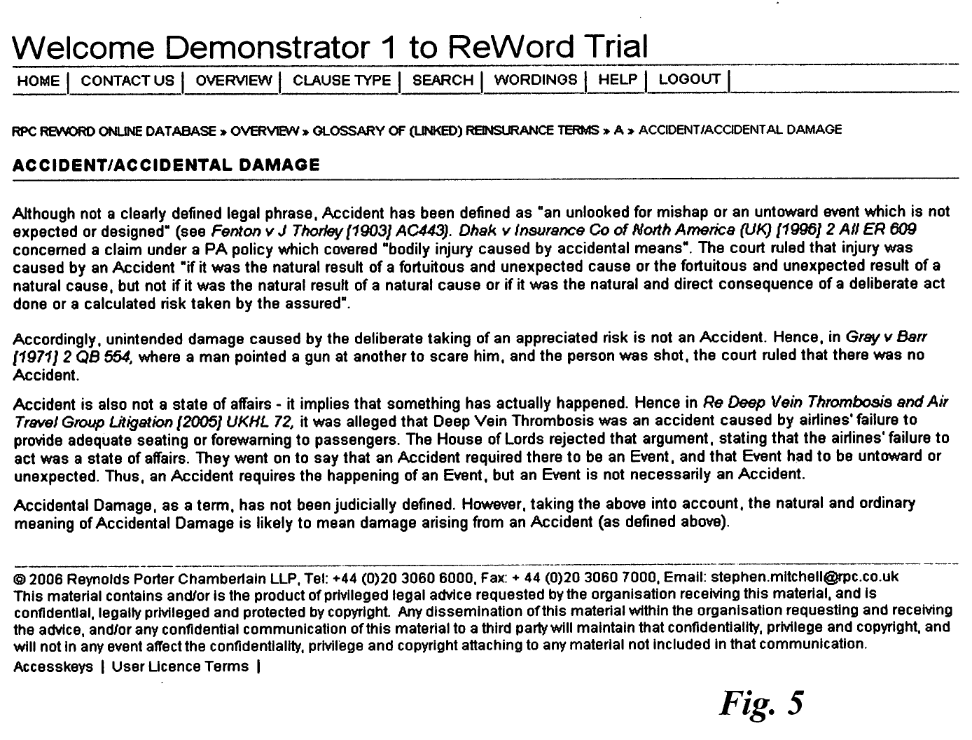

FIG. 5 illustrates a screenshot of an exemplary definition of a term used in reinsurance clauses;

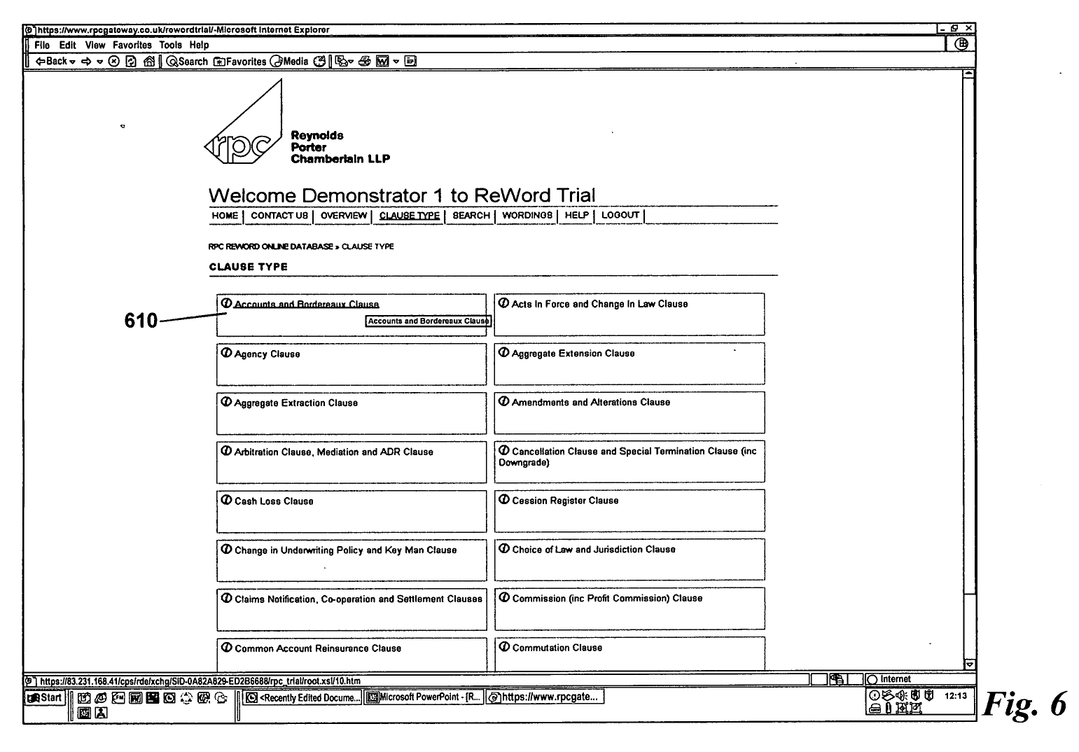

FIG. 6 illustrates a screenshot of a partial list of clause types;

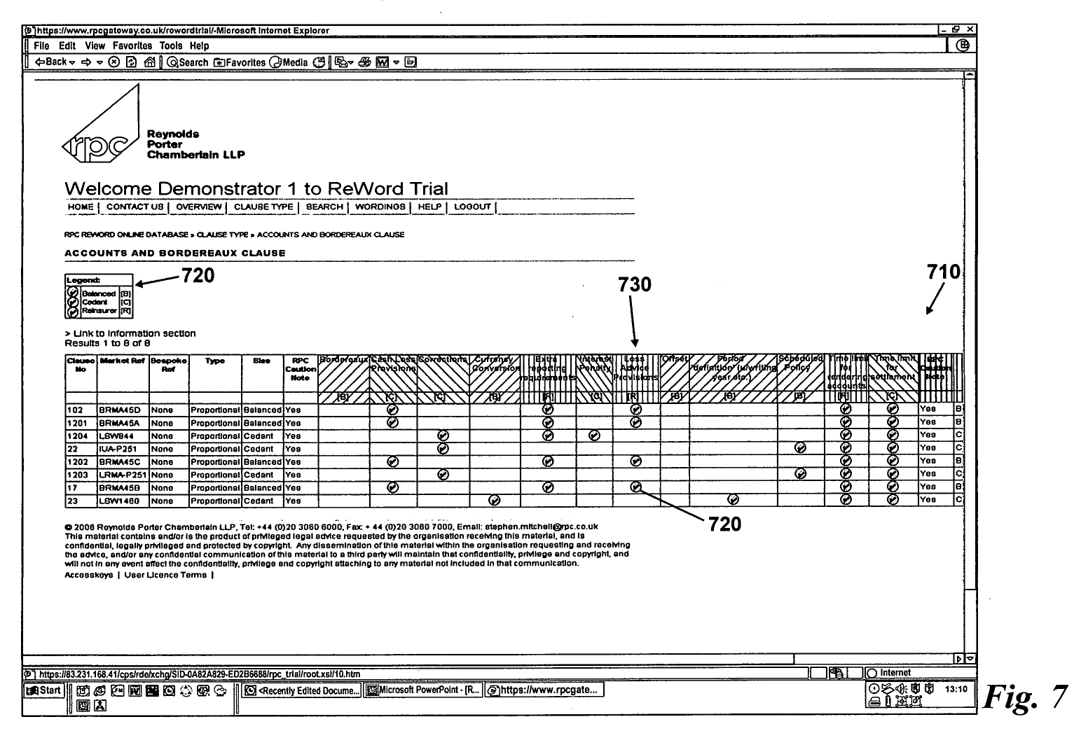

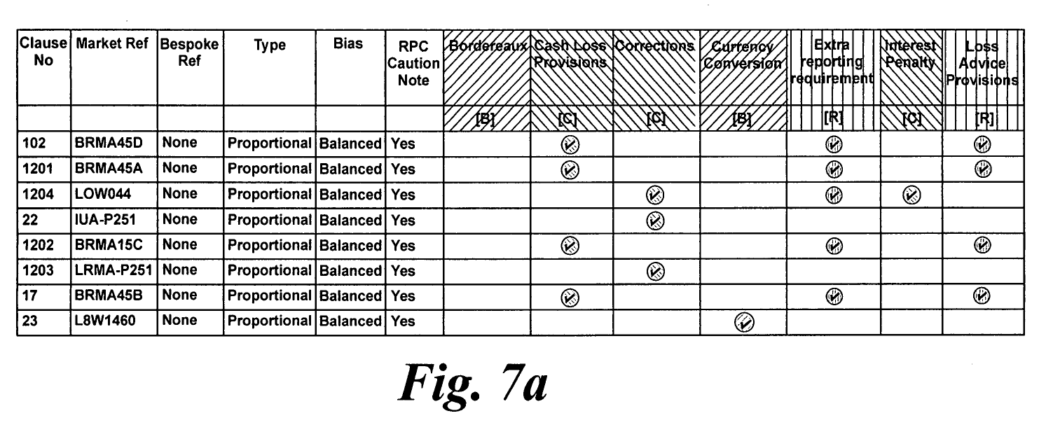

FIG. 7 illustrates a screenshot of an exemplary matrix of clauses within a clause type;

FIG. 7a shows a detail of the screenshot of FIG. 7;

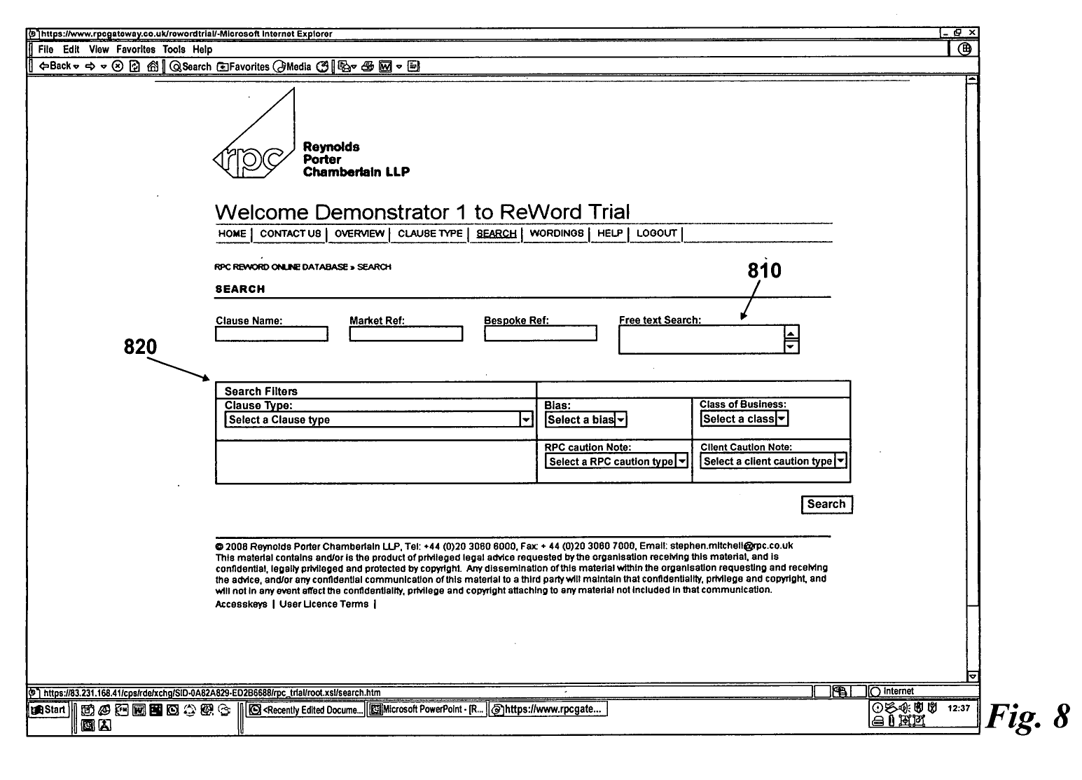

FIG. 8 illustrates a screenshot of a search facility;

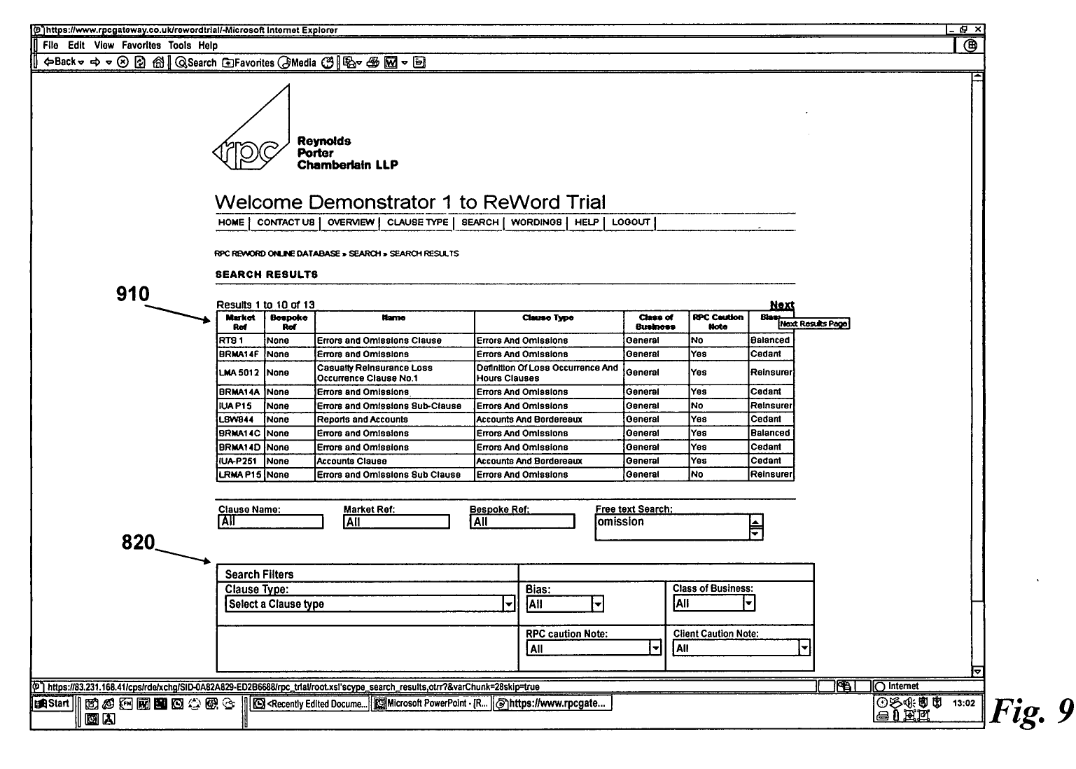

FIG. 9 illustrates a screenshot of exemplary results of a search;

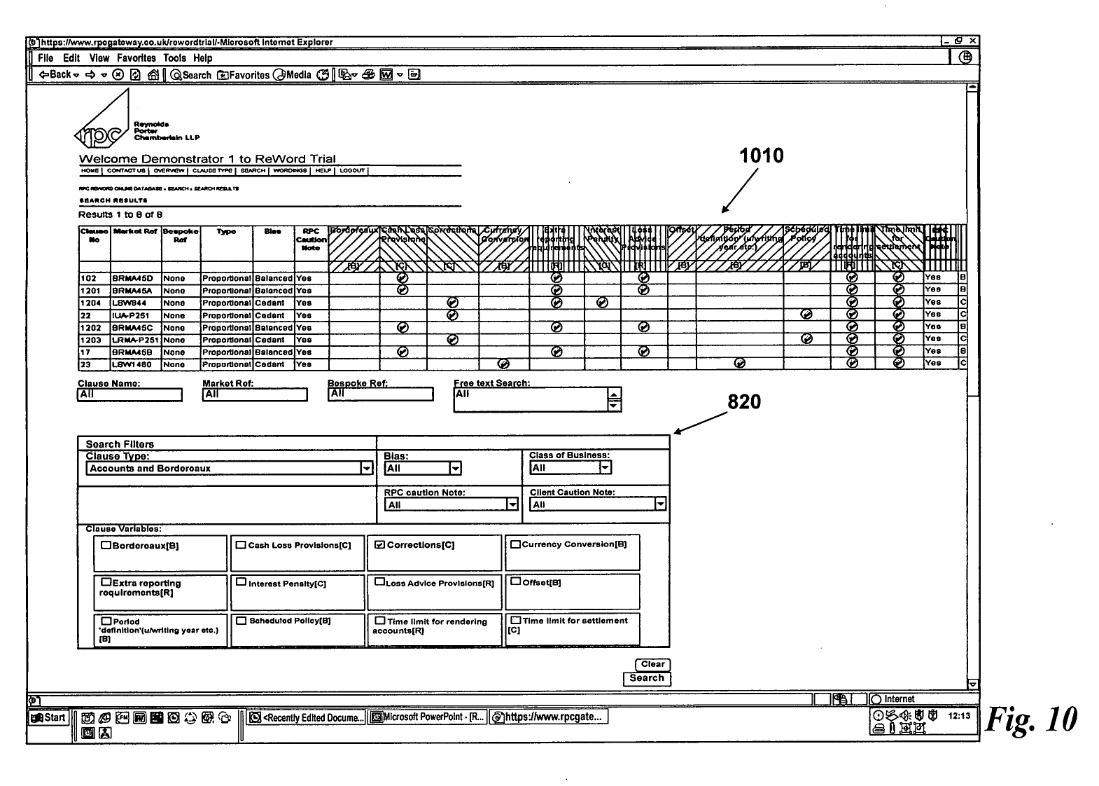

FIG. 10 illustrates a screenshot of a matrix of clauses resulting from a search;

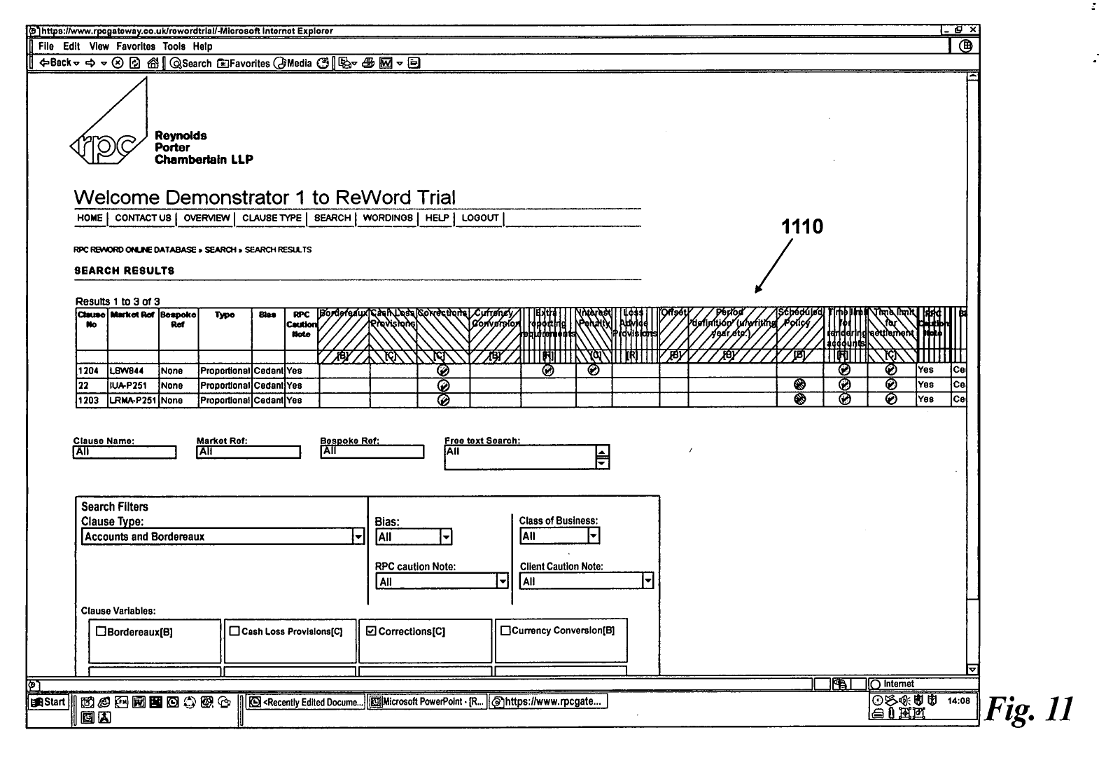

FIG. 11 illustrates a screenshot of a reduced matrix filtered from the results of FIG. 10;

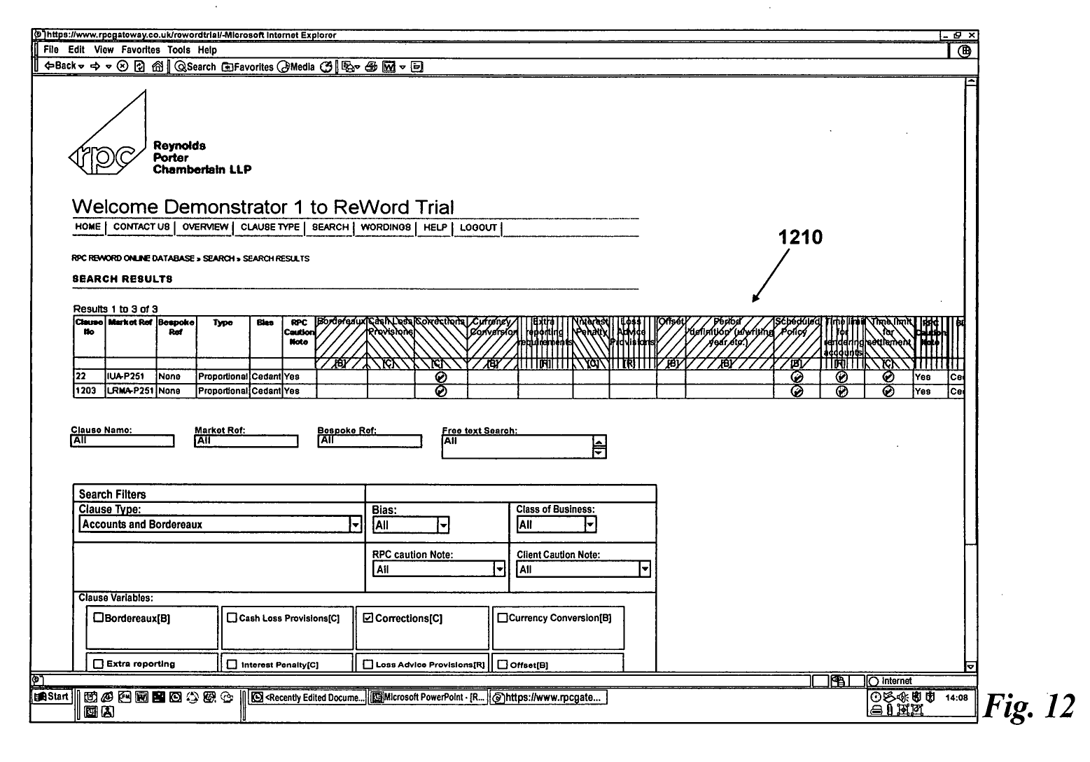

FIG. 12 illustrates a screenshot of a further reduced matrix filtered from the results of FIG. 11;

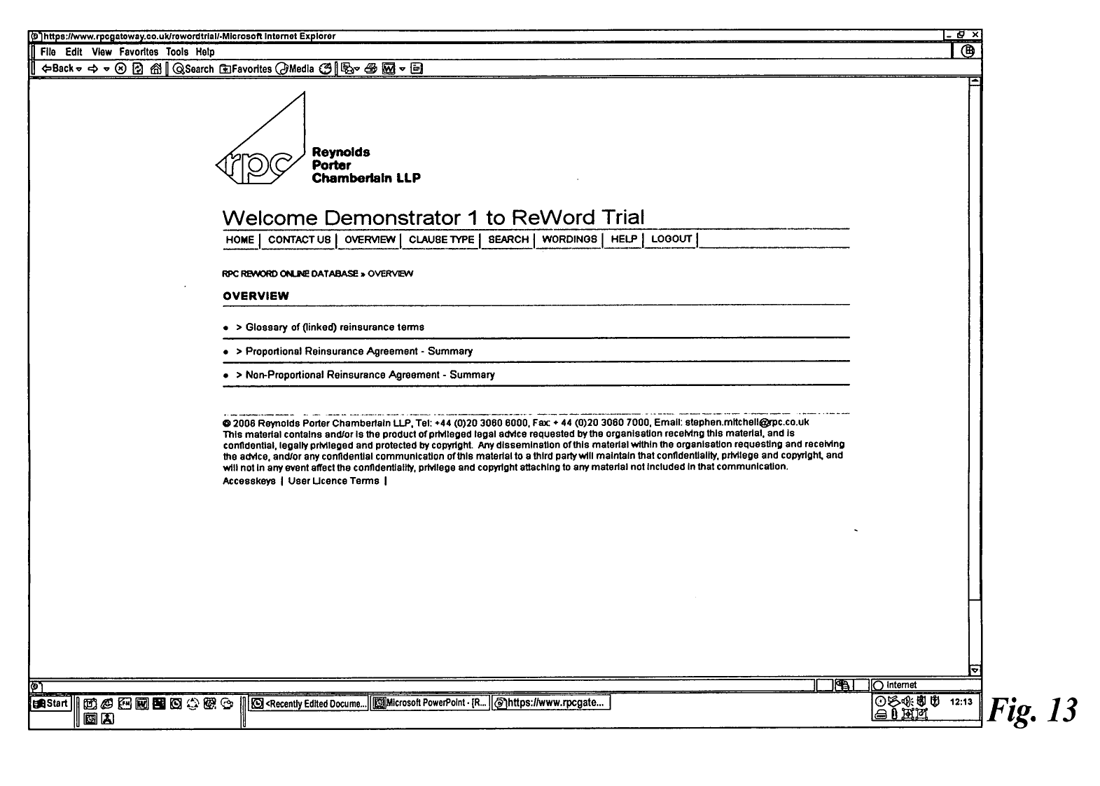

FIG. 13 illustrates a screenshot of an overview screen of the database;

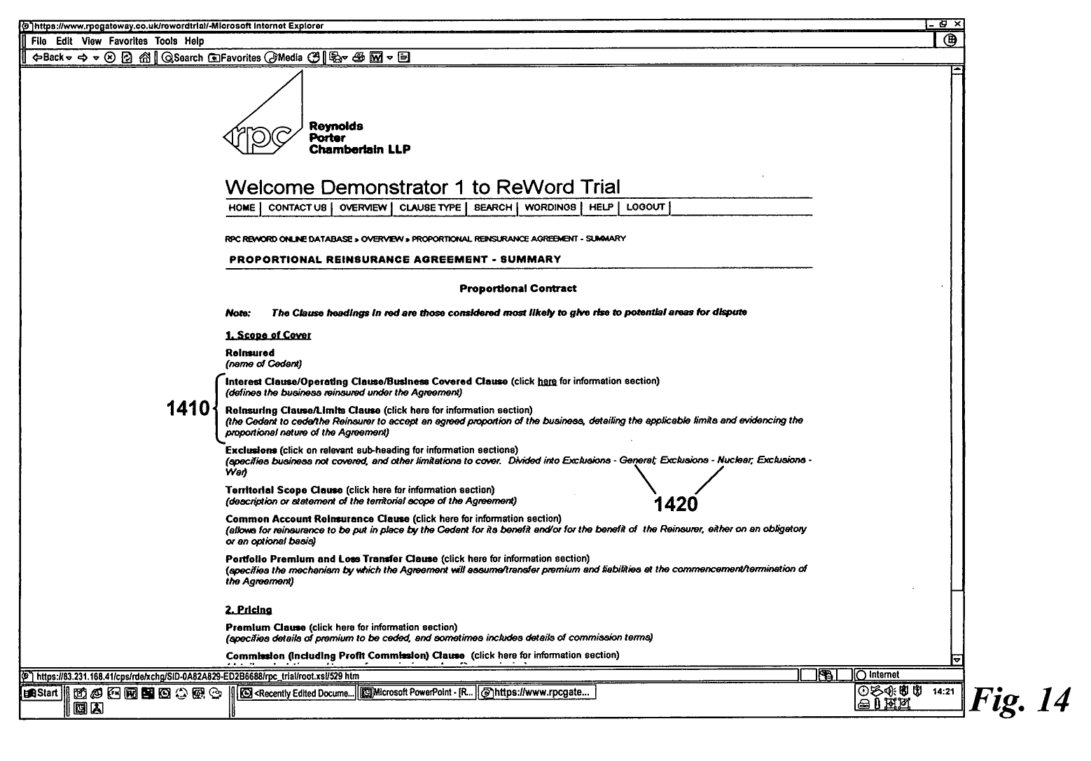

FIG. 14 illustrates a screenshot of a proportional contract summary;

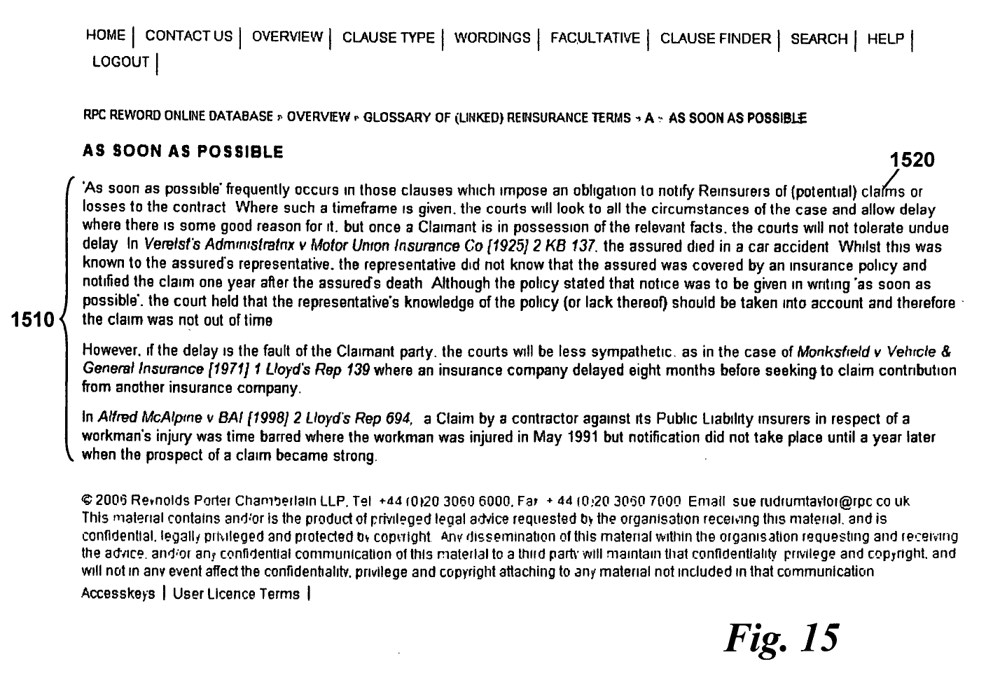

FIG. 15 illustrates a screenshot of an exemplary definition from the database glossary;

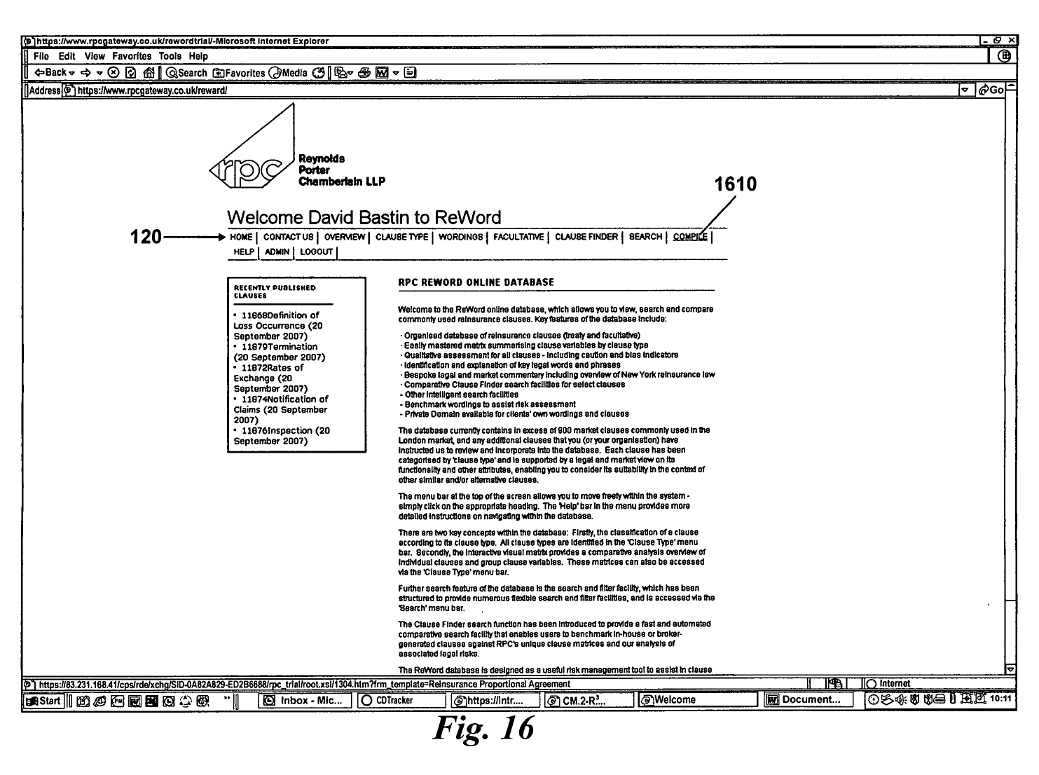

FIG. 16 illustrates a screenshot of an alternative welcome screen;

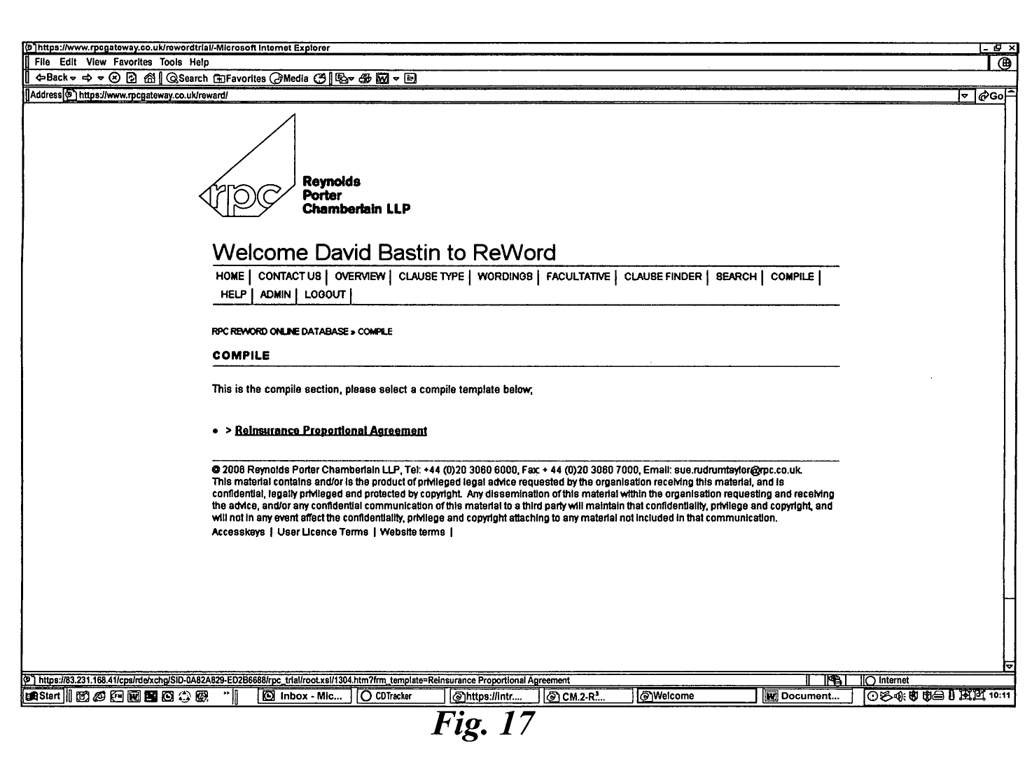

FIG. 17 illustrates a screenshot of a compile screen;

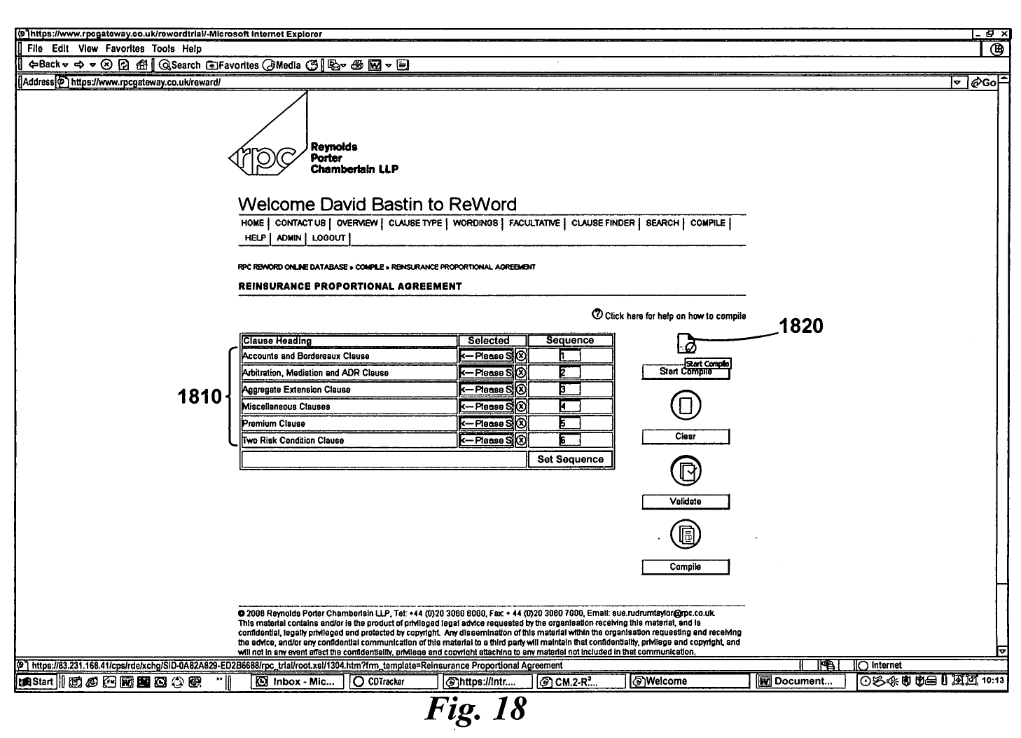

FIG. 18 illustrates a screenshot of a list of clause headings for compiling;

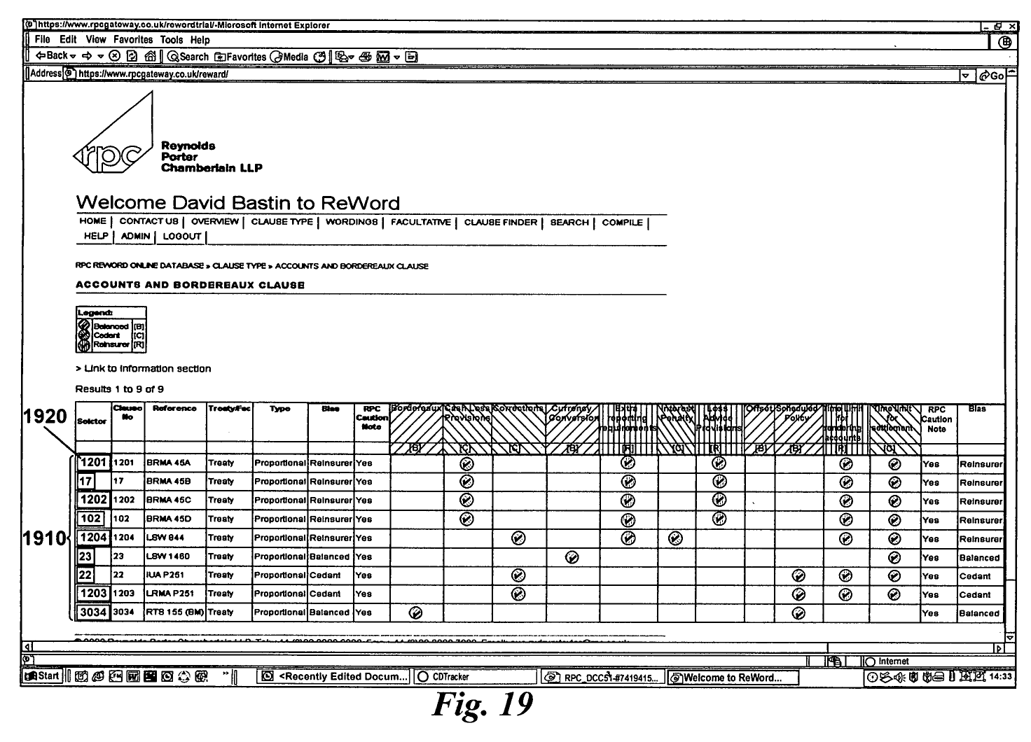

FIG. 19 illustrates a screenshot of a selection list of clauses for compiling;

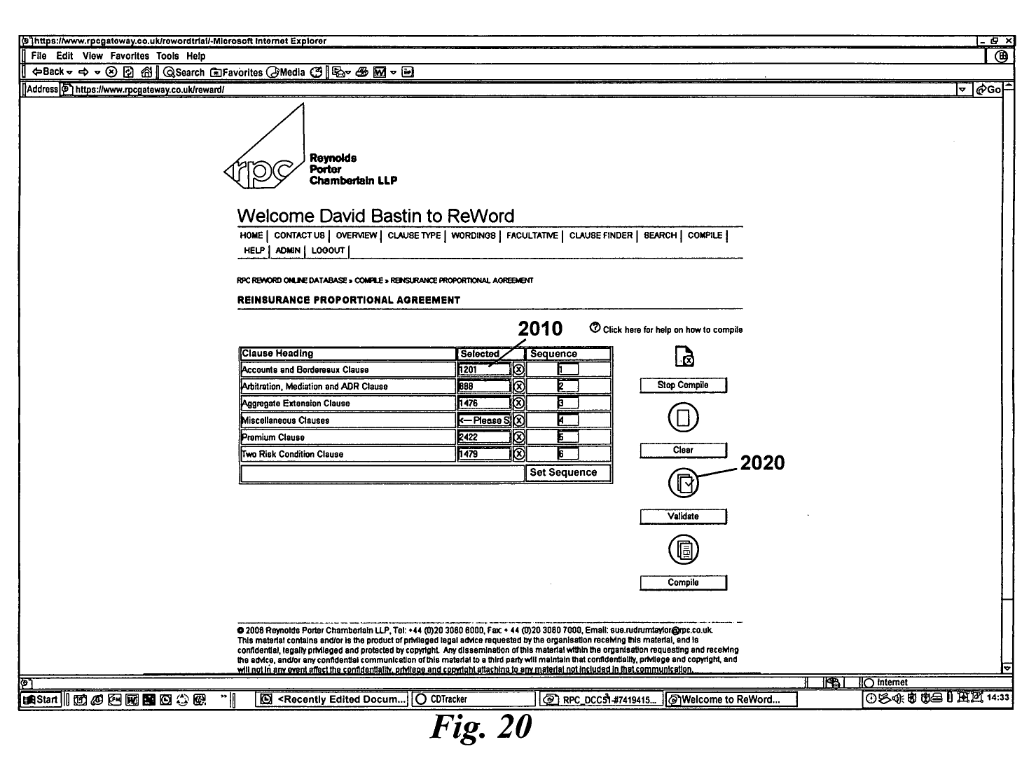

FIG. 20 illustrates a screenshot of the list of clause headings from FIG. 18 after selection of particular clauses;

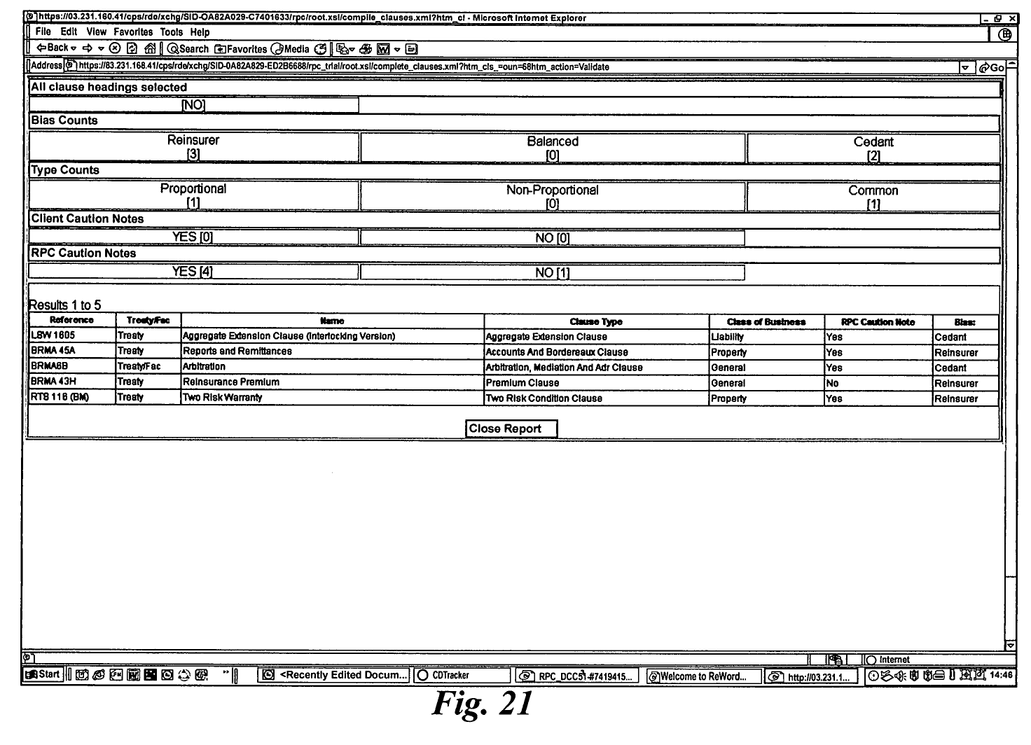

FIG. 21 illustrates a screenshot of a verification screen during compiling;

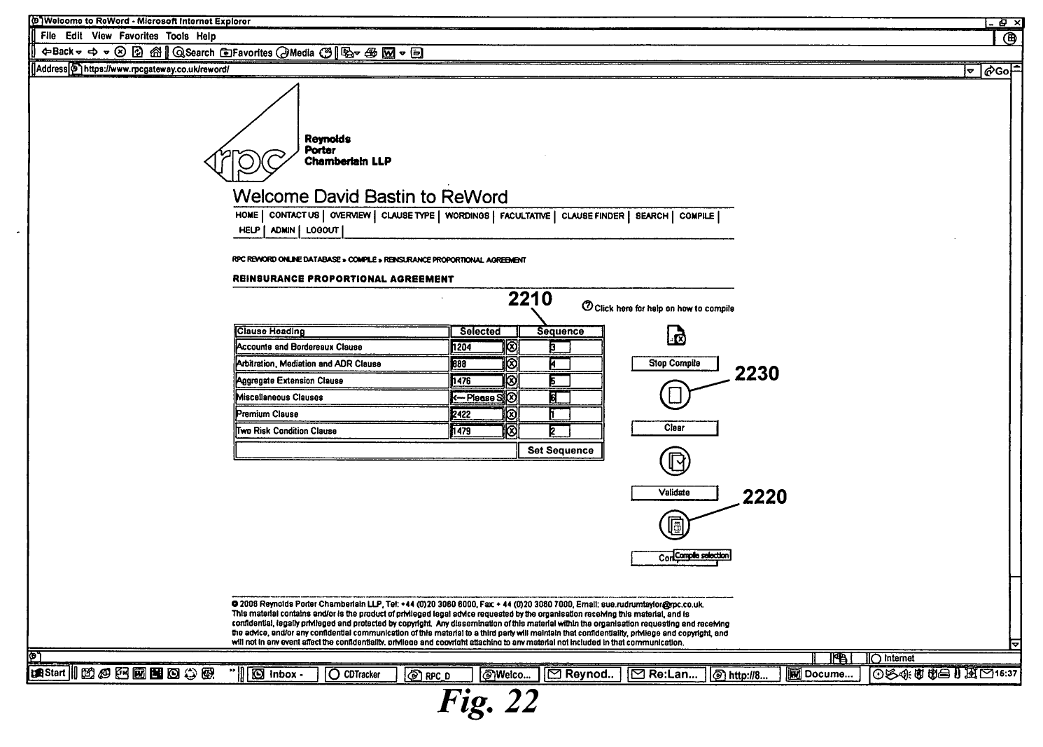

FIG. 22 illustrates a further screenshot of the list of clause headings prior to final compiling;

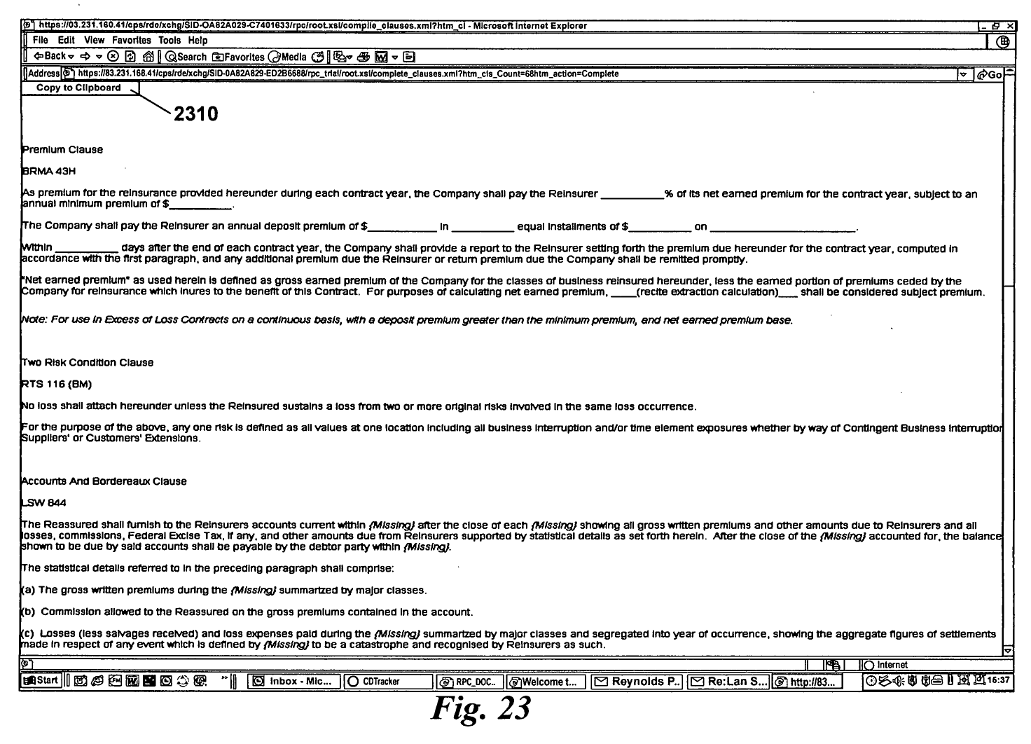

FIG. 23 illustrates a screenshot of an exemplary compiled agreement;

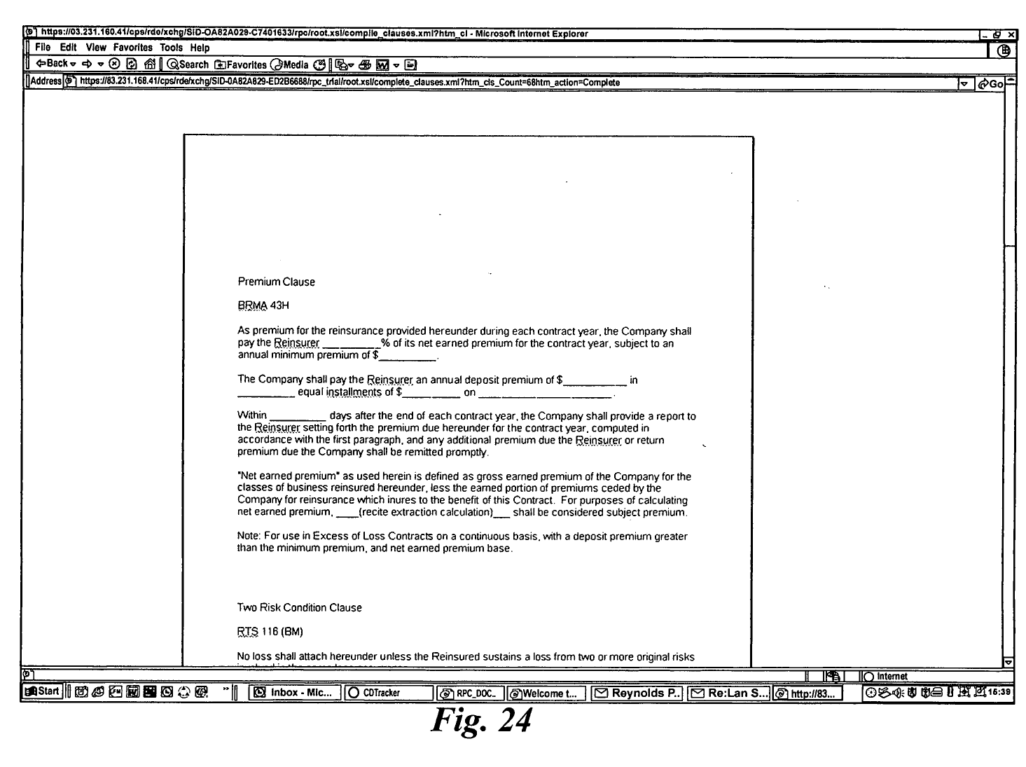

FIG. 24 illustrates a screenshot of the exemplary compiled agreement of FIG. 23, pasted into a word processing application screen;

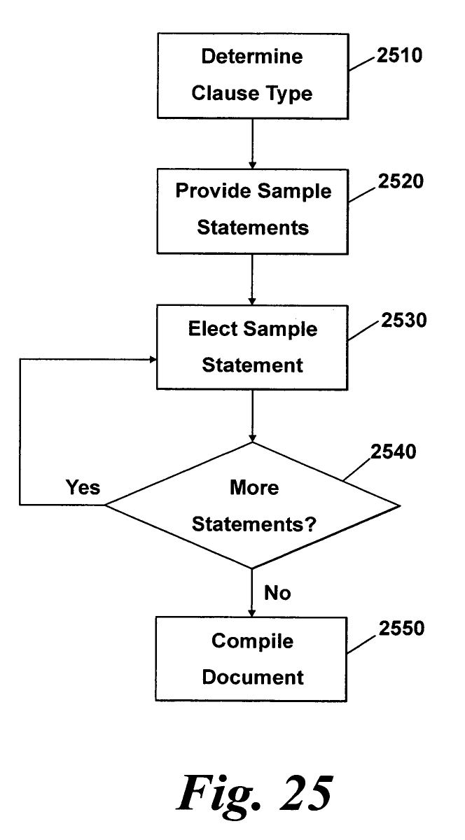

FIG. 25 illustrates a schematic flow diagram outlining a method according to an aspect of the invention;

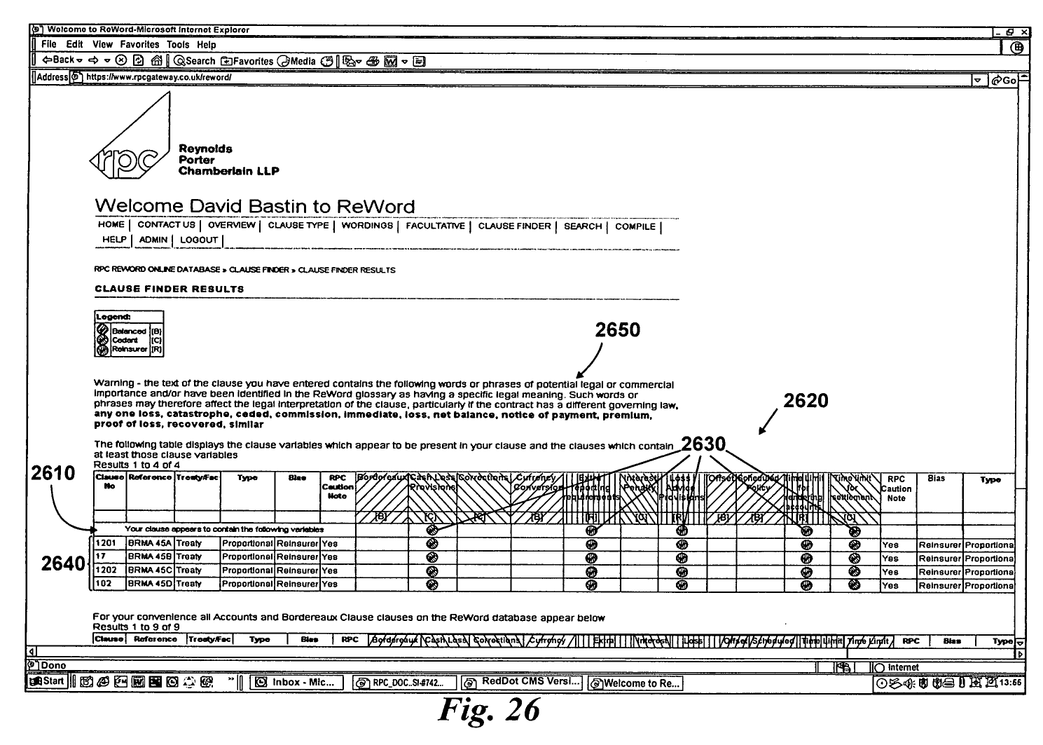

FIG. 26 illustrates a screenshot of an exemplary set of search results for a clause wording text search;

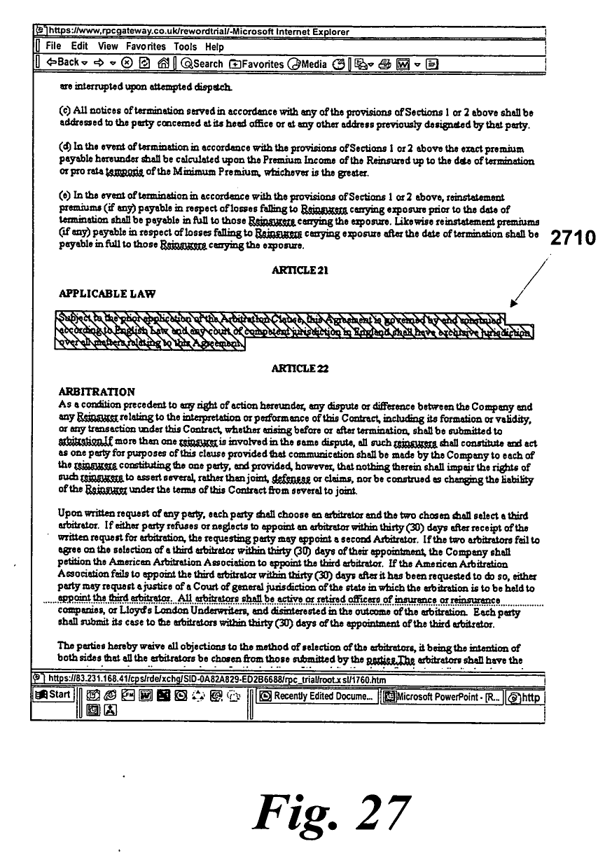

FIG. 27 illustrates a screenshot of a portion of an exemplary legal document;

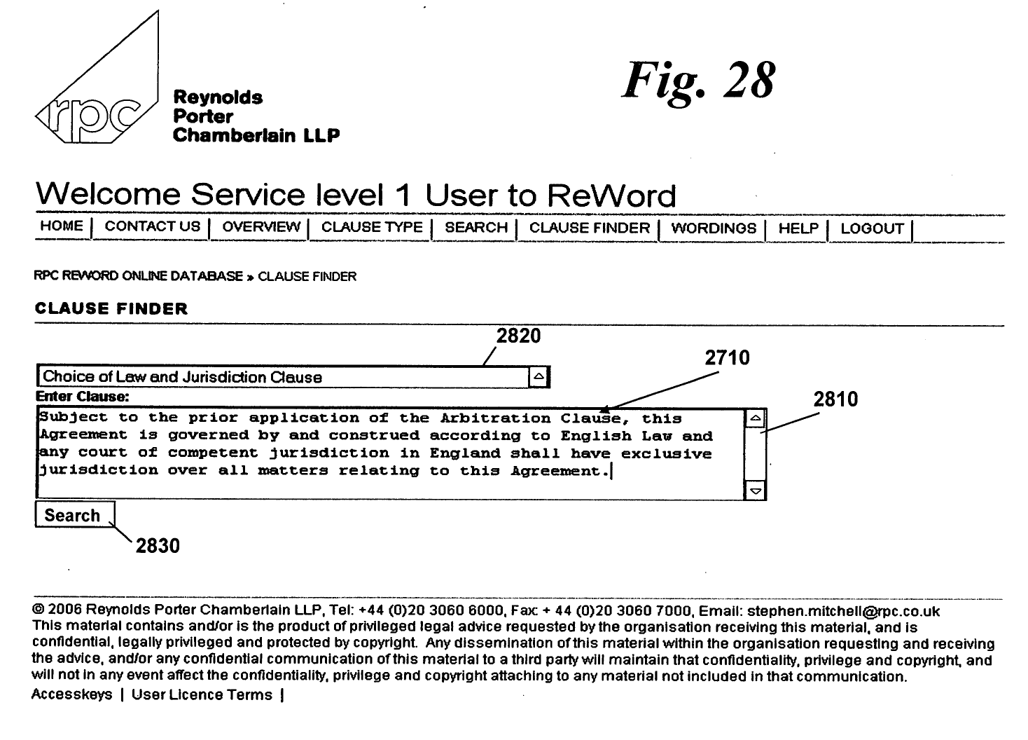

FIG. 28 illustrates a screenshot of a clause finder facility input with text from the legal document of FIG. 27; and

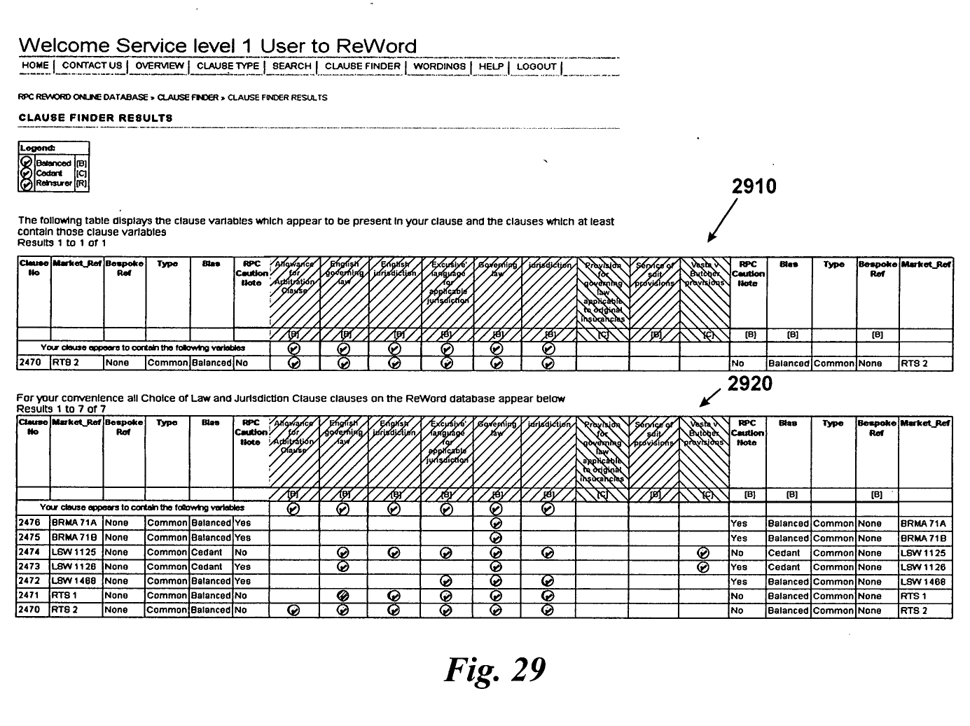

FIG. 29 illustrates a screenshot of exemplary search results from the clause finder facility.

At its most basic level, the invention can be considered to be an online, i.e. accessible either locally or remotely, interactive database (hereinafter called simply ‘database’). The database contains a large number of standard reinsurance clauses, combined with interactive legal commentary to explain the meaning of the clauses and in what context they should be used. Typically the database will contain several hundred such clauses, and may contain many more depending on the requirements and capacity of the system on which the database is to be run.

The database allows the creation of a standard benchmarking system to allow clients to compare clauses they are using against other standard clauses in the market. The database is intended to be a comprehensive collection of market-specific and client-specific reinsurance clauses, together with benchmark reinsurance wordings.

There are two main types of reinsurance contacts: proportional and non-proportional contracts. The database sets out the clauses one would expect to find in each of these types of contracts.

When displaying a summary of the headings found in a typical reinsurance contract in the database, certain clauses may be highlighted (e.g. in red), the highlighting representing the clauses that most commonly give rise to disputes. These have been identified by the inventors from a statistical analysis of the reinsurance case law in the USA and England from the past 10 years. Other words and phrases in the individual clause wordings and commentaries may be highlighted differently (e.g. in blue), the highlighted text being considered to have certain meanings when used in a legal context, some or all of which may have been judicially considered, i.e. in decided legal cases. Each of these words and phrases is hyperlinked to the relevant entry in the glossary.

The inventors have also created a method of grouping the clauses into related categories. This is not necessarily the order in which the clauses would usually appear in a Reinsurance wording, but the ordering helps in understanding how they fit together.

A typical welcome screen 100 for an exemplary embodiment of the database is shown in FIG. 1. A user is presented with the welcome screen, typically via a conventional interne web browser application. A menu bar 120 below the welcome message 110 allows the user to jump to a specific function of the system on which the database is presented, via hyperlinked text. Various specific functions on the menu bar 120 can include one or more of the following links:
a link (“home”) to the welcome page (or home page);
a link (“contact us”) to a page providing contact details;
a link (“overview”) to a library of related documents;
a link (“clause type”) to a structured listing of all available clauses within the database;
a link (“search”) to a search facility;
a link (“wordings”) to a library of wordings;
a link (“help”) to an online help facility; and
a link (“logout”) to logout the user from the database.

Other features may also be present on the menu bar. For example, a clause finder facility may be present, which allows a user to search for clauses in the database having particular wording. The clause finder facility is described in more detail below.

An information box 130 on the welcome screen shows a selected number of clauses that have been recently published, five of which are shown in the illustrated example.

Hovering over one of the clauses causes the clause title text to change colour and, by clicking on the text, the user is taken to a display for that clause, as shown in FIG. 2. Every clause in the database is preferably presented in the same structured form. The clauses are grouped by Clause Types and named accordingly, the clause type 210 shown in FIG. 2 provided with the clause type title “Definition of Loss Occurrence and Hours Clauses”, and the specific clause name 220 “ACOD (C) Employers Liability Workers' Compensation Definition of Occupational Disease Cover”. Internal and external market references 230 are presented for the clause and the type of business they relate to. Other information provided relating to the clause may include a client reference 240, a class of business and type of clause 250, a status message 260 (clauses being indicated as being Current until they are withdrawn from use), a reference 270 to the source of the clause, i.e. where the clause wording originated, and the actual wording 280 of the clause.

Referring to FIG. 3, which shows a continuation of the screen displayed in FIG. 2, further information provided for the clause can include legal comments 310 and relevant legal cases 320, each of which are intended to provide details of how the clause stands in the legal context. Market comments 330 explain the market context of the clause.

An indication of bias 340 shows whether the clause is biased towards being in favour of a Cedant or a Reinsurer, or whether the clause is balanced between the two. Bias comments 350 can be included to explain the rationale behind the determination of bias.

Referring to FIG. 4, which shows a continuation of the screen displayed in FIGS. 2 and 3, further information provided for the clause can include an indication 410 of whether caution is advised, and relevant caution notes 420. Where caution should be taken when considering a particular clause wording this is shown in the caution note 410 with an explanation in the caution comments 420. A client may be allowed to add their own personal notes 430, which are preferably only viewable by that particular client, for example only by selected employees of a client company. A clause variables list 440 displays the particular attributes of the displayed clause. A list 450 of potentially linked Clause Types shows other clause types that will need also to be considered when considering this wording.

Selected words used in a clause displayed on the database may be hyperlinked to a glossary. For example, wording 360 shown in FIG. 3 (“accident or event”) can be highlighted by being displayed in a different colour. Clicking on the link brings up a relevant page of the glossary, as shown in FIG. 5. The glossary allows a user to be provided with a definition of particular terms present in the contract. The glossary may also include references and commentary relating to any legal cases in which the relevant term has been considered. Typically, the glossary will include definitions of wording used in the specific context of reinsurance clauses. The glossary allows a client to understand that particular words used have associated meanings. These meanings may change depending on the governing law.

Legal analysis provided on the database may be prepared according to the law of only one jurisdiction, for example according to English law. As many clients within a particular jurisdiction and elsewhere might wish to write reinsurance contracts that are subject to other laws, comparative law analysis in other laws can be advantageously added to the database. For example, selected concepts of US reinsurance law, and comments on how certain clause types are interpreted, can be included to provide a comparative analysis of these concepts under their respective laws.

Returning to the functions available in the menu bar, as described above in relation to FIG. 1, clicking on the “clause type” link brings up a list of the available types of clauses, as shown in FIG. 6. Each clause type 610 is linked to a more detailed information section, which provides an overview of various market and legal information as well as other considerations and notes for the particular type of clause. The clause types are preferably displayed in alphabetical sequence for ease of access.

Each clause type shown in FIG. 6 is also linked to a clause matrix, which displays all clauses for the selected clause type. For example, the clause type “Accounts and Bordereaux” is shown in clause matrix form in FIG. 7. The clause matrix 710 shows a number, market reference, bespoke reference, type, bias and caution note, followed by various attributes or variables for the selected clause type and whether each particular example of the clause type has that attribute or variable. In the clause matrix 710 shown, attributes are shown by the presence of an indicator 720 (e.g. in the form of a tick) corresponding to a particular clause and a particular attribute. For example, clause number 17 is indicated as having a party bias status of a balanced bias in respect of the entire clause or sample statement, and has an indicator 710 corresponding to the loss advice provisions column 730. Each column 730 is provided with a characteristic associated with the party bias status corresponding to whether the attribute is balanced, in favour of the Cedant or in favour of the Reinsurer, each of which are indicated by [B], [C] or [R], as shown in the legend 720. These characteristics, which have been developed by the inventors, form part of the standard benchmarking methodology created for the database. Preferably the columns 730 and the indicators 720 corresponding to the presence of particular attributes are colour-coded. For example, a balanced attribute [B] can be colour coded blue, an attribute in favour of the Cedant [C] coded green and an attribute in favour of the Reinsurer [R] pink. The user can then easily determine the presence and types of attributes associated with various clause wordings, allowing the user to customize a particular contract.

The party bias status may be graded, for example there may be more than one level of bias towards the cedant and/or more than one level of bias towards the re-insurer.

Selecting the “search” link in the menu bar 120 (FIG. 1) brings up a search facility, shown in FIG. 8, in which various search criteria and filters can be input in order to find a particular clause or list of clauses having the required properties. For example, a clause can be searched for by entering text in a free text search box 810. As an example, searching for the word “omission” in this way brings up search results presented in the form shown in FIG. 9. The results are displayed in the form of a list 910 of relevant clauses, each clause in the list containing the searched-for term. Further details of each clause can be viewed by selecting a particular clause, each of which is hyperlinked to information relating to that clause, for example in the form shown in FIGS. 2 to 4.

Returning to FIG. 8, searching can also be carried out by filtering using one or more search filters 820. Such search filters may include clause type, bias, class of business, caution note and client caution note. Other filters may be included depending on other attributes of clauses in the database. As an illustrative example, applying a filter to select only those clauses relating to Accounts and Bordereaux brings up a results view shown in FIG. 10, in which a matrix display 1010 is shown for all clauses having that selected type. The search filters remain present in the display, to enable the user to refine further the list of clauses by applying further filtering criteria. For example, by applying the criterion of including only those clauses having a Corrections attribute (by checking the relevant box in the search filters 820) the size of the matrix is reduced to the matrix 1110 shown in FIG. 11.

Applying more than one filter reduces the number of results in the matrix yet further. For example, by additionally applying the filter “Scheduled Policy” to the results shown in FIG. 11, the results shown in FIG. 12 are produced, in which the matrix 1210 comprises only two clauses.

Returning to the functions available in the menu bar 120 (FIG. 1), the overview link provides the user with a library of documents, for example including a glossary of linked reinsurance terms, and summaries of proportional and non-proportional reinsurance agreements. An example overview screen is shown in FIG. 13. By selecting a document title, further information is obtained. For example, selecting the glossary of linked reinsurance terms brings up an alphabetical index of terms, allowing the user easy access to any particular term for which the database is able to provide a definition. The glossary is not intended to provide a comprehensive legal dictionary, but definitions for words that are actually used in the context of reinsurance clauses

Selecting, for example, a summary of a proportional contract brings up a summary of the various clause types that form part of a typical contract, as shown in FIG. 14. Each clause type is further linked to the various related clause information, and a matrix of the form described above can be obtained by linking through.

Certain clauses 1410 may be highlighted (e.g. in red), the highlighting representing the clauses that most commonly give rise to disputes. These have been identified by the inventors from a statistical analysis of the reinsurance case law in the USA and England from the past 10 years. Other wording 1420 may be highlighted differently (e.g. in blue), the highlighted text indicating a hyperlink to the relevant clause type on the database.

Within the individual clause commentaries, as shown at FIG. 3, certain words and phrases are highlighted differently, as shown by the words “accident” and “event” at 360. These are considered to have certain meanings when used in a legal context, some or all of which may have been judicially considered, i.e. in decided legal cases. Each section of highlighted text may be selected to bring up further information from the glossary in the database, which preferably includes information on legal cases in which the relevant term has been considered.

The user can thereby obtain further information relating to particular words and phrases either from the aforementioned alphabetical list of terms, or from hyperlinks within exemplary clauses. For example, if the wording “as soon as possible” is selected, a screen such as that shown in FIG. 15 is brought up, in which information 1510, including the legal context of the wording, is provided, possibly with further wording 1520 linked to other information from the glossary.

The inventors have also developed benchmark wordings and additional clause matrices for facultative reinsurance wordings (i.e. reinsurances of individual risks rather than a treaty in respect of many risks). This makes the database relevant for facultative reinsurance underwriters, in addition to treaty reinsurance underwriters and related professionals.

Preferably the database is configured to allow for modular access control, i.e. to allow various levels of access depending on a particular user's setting. Certain users may then be given access to functions not available to other users. For example, a compile function 1610 may be available to selected users, accessible from the menu bar 120 on the welcome page, as shown in FIG. 16. The compile function allows a user to assemble a customised agreement containing clauses of types most suitable to the user's particular requirements. The following describes the general process involved in compiling an agreement.

Following the link on the compile screen, the user is provided with one or more templates relative to the contract wording the user wishes to compile. FIG. 17 shows a compile screen in which only one template is shown, that of a proportional reinsurance agreement. Other types of agreement may also be present. Selecting the agreement brings up a Compile Control screen, shown in FIG. 18. This screen shows the different types of clauses 1810 available for compiling. The clause types that can appear in the wording of the relevant agreement are displayed in the list 1810. Selecting the “Start Compile” icon 1820 begins the compiling process, and the icon 1820 immediately changes to read “Stop Compile” (shown in subsequent Figures), to allow the user to stop the compiling process before completion.

Selecting a particular clause brings up a further screen for the clause selected, for example as shown in FIG. 19 showing the relevant screen for the clause type “Accounts and Bordereaux”. A list 1910 of alternatives is presented for the particular clause type, each having associated clause attributes or variables, with party bias status for the entire sample statement and in respect of the variables or attributes, as described above in relation to FIG. 7. The user selects the most appropriate clause wording for their particular requirements. For example, the clause number 1201 may be selected because it contains cash loss provisions, an extra reporting requirement, loss advice provisions, a time limit for rendering accounts and a time limit for settlement, with an overall bias in favour of the reinsurer. The clause can be selected by selecting the relevant selector button 1920 alongside the clause.

Returning to the compile screen, shown in FIG. 20, the relevant clause number is now entered in the clause selection box 2010. The above process is repeated for each of the clause headings, resulting in clause numbers being input into each clause selection box. If one or more particular clause headings are not required, these can be left un-selected.

Once all clauses required are selected, a summary report can then be created by selecting the ‘validate’ icon 2020. This brings up a further screen, shown in FIG. 21, in which a summary of the selected clauses is provided. The summary indicates whether a clause has been selected for each heading, a count of the bias towards Cedant, Reinsurer or balanced, counts on proportional, non proportional and common, plus counts on Cautionary notes. Finally the selected clauses are listed, each of which can be shown in more detail by being selected.

Clause types can be re-selected as required. The sequence in which the clauses are assembled in the final document can also be selected, as shown in FIG. 22, where the sequence column 2210 has been amended to alter the relative order of the clauses. The compile function can be stopped at any time and re-started at a later time from the point where it was left off. The selections made up to that point are saved on the database. The currently selected clauses can be cleared by using the “Clear” button 2230.

In relation to the clause-type and/or the wording text, sections of the text and/or alternative texts can be colour-coded to represent a bias towards cedant and re-insurer as appropriate; accordingly, such sections of text can be selectively included or excluded according to the required direction of the contract.

Finally, by clicking on the “compile” button 2220, each of the selected clauses are automatically assembled into a single document, in the order specified.

The assembled text resulting from the compiling process is displayed in a new window, as shown in FIG. 23. Using the “Copy to Clipboard” button 2310, the text on the screen is copied to the clipboard, and is then available to be pasted into another application, such as a word processing application. FIG. 24 shows the text pasted into an exemplary word processing application. User-specific formatting can then be applied, and the agreement is ready to be used.

The compile function utilises elements of a document template and the clause matrices.

A skeleton document (FIG. 23) is created and states each clause type for which a clause should be present. There is no restriction to the number of skeletons that can be created in the Content Management System editor. When a new skeleton is published online it then becomes available for use in the compile function. The subscriber can select which skeleton they wish to use.

A control table may be provided (FIG. 18), the table having links to the appropriate clause matrix (FIG. 19) for each section of the document. The subscriber can click on a selected link to display the relevant clause matrix. Using the variables assigned to each clause the subscriber can select the clause that is best suited for their requirements. The clause identifier is entered into the control table. When all clause types have been actioned the subscriber can compile the wording which inserts each clause wording into a separate window on his/her PC. The content of this window (FIG. 23) can then be copied to his/her clipboard and pasted into a standard word processing package of their choice (FIG. 24).

FIG. 25 illustrates, in a general aspect, the principle steps of the method of compiling a legal document, for example a reinsurance agreement, according to an aspect of the invention. In a first step 2510, the clause type to be included is determined, for example as illustrated above in relation to FIG. 18, where a list of clause types is presented to a user and the user determines through selection of one or more clause types which is to be included in the agreement. In a second step 2520, at least one sample statement is provided for that clause-type. This step corresponds to the screen shown in FIG. 19, in which a list of sample statements 1910 is provided to the user, one of which may be selected for the particular clause type. In a third step 2530 a sample statement is selected, corresponding to selection of a sample statement from the list 1910 provided, and including this sample statement in the list of clause headings (FIG. 20). A decision is made, at step 2540, regarding whether any more statements need to be included, this step corresponding to returning to the compile screen (FIG. 21) and determining if all the clause headings required to be present are in fact present. If any more statements need to be included, step 2530 is repeated. When there are no more statements to be included, the document is compiled at step 2550, corresponding to the creation of wording shown in FIG. 24, and optionally copying this wording to a word processing application (FIG. 25).

There are various technical features and advantages of the database according to the present disclosure, and how these differ from what can be achieved using generally available non-customised software, detailed as follows.

Whilst matrix presentation of information is commonplace and the majority of spreadsheet packages can be used to create matrices, matrices according to the present disclosure provide a number of unique features. The matrices are dynamically created when viewed by a user, for example via the website on which the database is presented. Unlike a spreadsheet, which has a set number of columns, matrices presented in the database vary from one clause type to another. A single template is preferably used, having fixed portions at the beginning and end but with central columns containing the clause variable information automatically expanded according to the number of variables to display. This is achieved by creating categories for each clause type, with a list of variables assigned to each category as keywords. New variables can consequently be added at any time. These are automatically inserted in alphabetical order, and existing variables moved accordingly.

A Content Management System (CMS) is preferably used to manage the variables associated with each clause in the database, the CMS being accessible by authorised users (i.e. managers) of the database.

When a matrix of clauses is displayed, for example as shown in FIG. 7, the variables or attributes present for each particular clause are shown. Again, this information is built dynamically rather than being static, which enables new variables to be added at any time to the database.

The relationships between a clause and its variables are maintained within the CMS and subsequently published online, for example to the website. When viewed online these relationships are, for example, converted into tick marks within the matrix, as shown in FIG. 7.

The letter in square brackets at the end of each variable name denotes whether the variable is biased towards a Reinsurer, Cedant or Balanced between the two. This is displayed on a separate line in the matrix to highlight its importance. This is also used to colour code the ticks within the matrix as described previously.

When the matrix is constructed, all listed clauses are provided with an active link (i.e. a hyperlink) to the full clause details. This enables easy access for a user to a more detailed view from any point in the matrix.

When client clauses are added to the database, clients can elect to have their clauses seen by all subscribers, or alternatively restricted to subscribers from their company. This can be achieved by adding a Clause Client Code to the clause within the Content Management System editor. The code relates to the Company who submitted the clause and is also stated when a subscriber logon is set up.

When the matrix is dynamically constructed the logged on user details are inspected and only clauses he/she has authority to see are displayed in the matrix.

A clause finder facility within the database utilises text searching technology, but can be implemented to produce results quickly without impairing the service performance for other users whilst searches are carried out. The vocabulary of words and phrases can be easily maintained without requiring continual amendment of search rules by specialist IT programmers. Categories and keywords are established to control the clause matrix displays, and lists of words and phrases can be assigned to each clause variable for ease of searching.

The Content Management System editor can be customised to enable non IT staff to create vocabulary rules for each matrix variable via a vocabulary rules editor facility. The vocabulary editor can have the ability to specify the following combination of rules:
Single positive cases (switch on variable as present)
Multiple positive cases (switch on variable as present if all contained)
Single negative cases (switch off variable as present)
Multiple negative cases (switch off variable as present if any contained)
Hybrids of positive and negative cases (and any mix of single and positive)
Complete override rules (switch off variable as present)

An example is shown in table 1 below, which illustrates various options presented to a user relating to editing rules for an exemplary set of phrases.

TABLE 1
editing rules for various phrases.

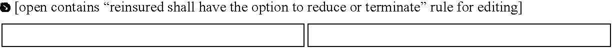

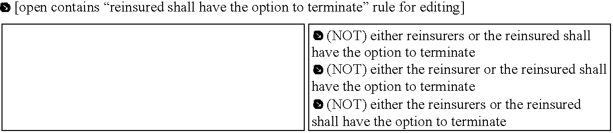

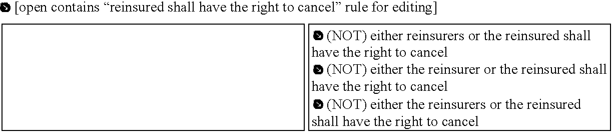

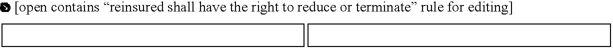

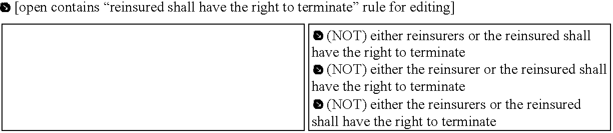

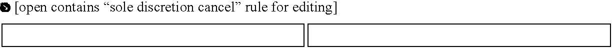

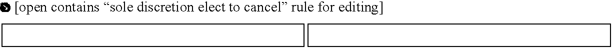

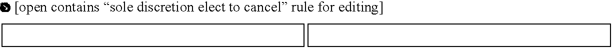

If new variables are added to the matrix then new rules can also be added to the Vocabulary Rules. As the rules are processed in alphabetical order, a new rule is always inserted at the correct, relative position.

To improve the performance of searching, the search is driven from the variable/vocabulary side rather than the subscriber's input wording.

The following sequence repeats for each variable in the matrix application to that clause type:

a) Check for the presence of Override text strings. As soon as one is found then move to the next variable and keep this variable ‘switched off’.
b) Check each vocabulary rule and if found to be present and not switched off by a NOT rule ‘switched this variable on’ and move to the next variable. (This way processing stops when it finds a true condition)
c) When all variables have been inspected a search of the database is performed to return all clauses within the selected type that have as a minimum the selected variables.
d) The results are shown in the standard matrix but with an additional introduction line which shows the variables present in the subscribers clause.

An exemplary set of results in matrix form is shown in FIG. 26. In the first row 2610 of the matrix 2620, tick marks 2630 are shown to indicate which of the variables searched-for appear to be present in the text of the clause searched for. A list 2640 of possible standard clause wording from the database, in which the wording corresponds to the variables present, is provided as part of the search results.

The clause finder also highlights any words within the submitted clause that may need consideration because of their legal of business meaning, for example as warning text 2650 above the matrix 2620. This list of words is maintained in the Content Management System editor and published to the website. Again, this list can be added to at any point and then republished to take immediate effect.

Using the clause finder facility, searches can be initiated by selecting a clause type and entering text from a clause to be searched. An example of a sequence of steps using the clause finder is illustrated in FIGS. 27 to 29.

Shown in FIG. 27, a selection of text 2710 can be made from a pre-existing agreement. In the example shown, the selection of text 2710 forms the section of the agreement under the “Applicable Law” heading. This text 2710 is copied to the clipboard.

Referring to FIG. 28, the selection of text 2710 is pasted directly into the clause search text box 2810. The pull-down menu 2820 appropriate to the clause type is selected, which in this case is the “Choice of Law and Jurisdiction Clause”. The search is then initiated, for example by selecting the search button 2830.

FIG. 29 shows exemplary search results obtained from the clause finder facility. The attributes determined by the clause finder to be present in the searched-for text are used to select all clauses present in the database having at least the same attributes (although they may have more). Two matrices are then displayed. The first matrix 2910 shows those clauses with at least matching attributes to the searched-for text 2910, and the second matrix 2920 shows all of the clauses on the database within that clause type.

In a general aspect therefore, the clause finder provides a method of analysing a legal document according to a portion of text from the legal document having a clause type, the clause finder providing search results for that clause type in the form of search results comprising one or more clauses from a database of clauses, wherein the search results comprise those clauses in the database having attributes present in the portion of text. The search results are preferably in the form of one or more matrices, each of the one or more matrices comprising clauses having matching attributes to the portion of text.

While the above description of the invention relates to reinsurance agreements, this should not necessarily be interpreted as meaning that the invention is limited to only the field of reinsurance agreements. Principles of the invention may be additionally applicable to the creation and validation of other types of legal documents.

Other embodiments are also intentionally within the scope of the invention, as defined by the appended claims.

1. A computerised method of compiling a legal document between two or more parties, the method comprising:
determining a first user input defining a clause-type to be included in the document;
providing at least one sample statement for that clause-type; and
electing a sample statement for the clause-type for input to the legal document, wherein a party bias status is provided in relation to the at least one sample statement.

2. A method according to claim 1 wherein the party bias status is provided in respect of the entire sample statement.

3. A method according to claim 1 wherein the party bias status is provided in respect of an attribute associated with the clause-type.

4. A method according to claim 3 wherein the party bias status is a graded party bias status.

5. A method according to claim 4 wherein the party bias comprises at least three levels of grading comprising a set of one or more grades indicating a bias towards one party, a set of one or more grades indicating a bias towards the other party, and a grade indicating a neutral bias.

6. A method according to claim 5 comprising analysing the party bias status of two or more of an entire sample statement and/or of one or more attributes associated with a clause-type.

7. A method according to claim 6 comprising effecting a statistical analysis on a plurality of an entire sample statement and/or one or more attributes associated with a clause-type.

8. A method according to claim 7 comprising selecting one or more of an attribute and an entire sample statement in accordance with a predetermined overall bias level.

9. A method according to claim 5 comprising representing a party bias status and/or grading thereof by colour.

10. A method according to claim 1 comprising:
forming a matrix of a plurality of sample statements for each of which there is indicated a party bias status in relation to the sample statement.

11. A method according to claim 10 comprising compiling a legal document with at least one statement devised from the electing step.

12. A method according to claim 1 comprising providing search results in response to an input clause text, the search results indicating the presence of one or more variables in the input clause text, the variables corresponding to attributes of sample statements present in the database.

13. A method according to claim 12 in which the sample statements containing the variables present in the input clause text are provided in the search results.

14. A computer program product directly loadable into the internal memory of a digital computer, comprising software code portions for performing the method of claim 13 when said product is run on a computer.

15. A computer program directly loadable into the internal memory of a digital computer, comprising software code portions for performing the method of claim 13 when said program is run on a computer.

16. A carrier, which may comprise electronic signals, for a computer program of claim 15.

17. The carrier of claim 16 further comprising means for electronic distribution of said computer program.

18. A database for the provision of a matrix on a website, the matrix comprising data relating to a clause-type to be included in a legal document between two or more parties; the matrix including a plurality of sample statements, for each of which there is indicated a party bias status in relation to the sample statement.

19. A database according to claim 18 comprising data for applying a party bias status in respect of the entire sample statement.

20. A database according to claim 19 comprising data for applying a party bias status in respect of each of one or more attributes associated with the clause-type.

21. A database according to claim 20 comprising data for applying a graded party bias status.

22. A database according to claim 21 comprising data for applying at least three levels of grading comprising a set of one or more grades indicating a bias towards one party, a set of one or more grades indicating a bias towards the other party, and a grade indicating a neutral bias.

23. A website operable for compiling a legal document between two or more parties, the website comprising a matrix having data relating to a clause-type to be included in a legal document between the two or more parties, the matrix including a plurality of sample statements, for each of which there is indicated a party bias status in relation to the sample statement.

24. A system for compiling a legal document between two or more parties, the system comprising:
a database comprising a plurality of sample statements, each of which sample statement is provided with an associated party bias status;
a first user interface for defining one or more clause-types to be included in the legal document; and
a second user interface for selecting a sample statement from the plurality of sample statements for each of the one or more clause-types, the second user interface providing a party bias status in relation to the sample statement.

25. The system of claim 24 comprising a third user interface for compiling the legal document from the one or more clause-types and selected sample statement associated with each of the one or more clause-types.

26. The system of claim 25 comprising a fourth user interface for validating the one or more clause-types and selected sample statements associated with each of the one or more clause-types, the fourth user interface including a summary of party bias status in relation to each of the one or more sample statements.
